(19) United States
(12) Patent Application Publication
(10) Pub. No.: US 2009/0114168 A1
(43) Pub. Date: May 7, 2009

(54) Motor vehicle fuel reformation system

(76) Inventors: Dennis Lee, Newfoundland, NJ (US); Michael Holler, Honey Grove, PA (US)

Correspondence Address: THOMAS J. GERMINARIO, ESQ., 154 ROUTE 206, CHESTER, NJ, 07930, US

(21) Appl. No.: 12/318,557

(22) Filed: Dec. 31, 2008

Related U.S. Application Data
(63) Continuation-in-part of application No. 12/149,961, filed on May 12, 2008.
Application No. 12/149,961 is a continuation-in-part of application No. 11/889,226, filed on Aug. 10, 2007, now Pat. No. 7,487,764.

(51) Int. Cl. F02B 43/10

(52) U.S. Cl. 123/3; 701/103

(57) ABSTRACT

A method and apparatus for reforming a hydrocarbon fuel within a motor vehicle increases its energy content, improves its combustibility and reduces combustion by-products. The hydrocarbon fuel is cracked during multiple passes through a reactor vessel by means of electrochemical interactions with a reactor rod composed of a magnetic and/or catalytic material. Various different fractions of reformed fuel can be recovered and used either within the vehicle or externally.

### CROSS-REFERENCES TO RELATED APPLICATIONS

This application is a continuation-in-part of application Ser. No. 11/889,226, entitled “Pre-Ignition Fuel Treatment System”, by Dennis Lee, filed Aug. 10, 2007, and application Ser. No. 12/149,961, entitled “Improved Pre-Ignition Fuel Treatment System”, by Dennis Lee and Michael Holler, filed May 12, 2008. The entire contents of application Ser. Nos. 11/889,226 and 12/149,961 are incorporated herein by reference.

### BACKGROUND OF THE INVENTION

The present invention relates to an apparatus and process by which a motor vehicle equipped with an internal combustion engine can reform a heavy hydrocarbon fuel to produce various grades of lighter hydrocarbons fuels, and thus operate as a mobile refinery. The present invention also relates to an apparatus and process by which some of the fractions of reformed hydrocarbon fuel are used to power a generator to produce electricity for use outside the motor vehicle, which thereby operates as a mobile power plant as well.

The present invention improves combustion efficiency and reduces polluting combustion by-products of internal combustion engines by reforming the hydrocarbon fuel to render it more readily and completely combustible. This is accomplished by a pre-ignition fuel treatment system in which large, complex hydrocarbon molecules are “cracked” or broken down into smaller, simpler molecules. These simpler hydrocarbons are more readily combustible and produce fewer combustion by-products. Hydrocarbon “cracking” is a highly endothermic reaction, which means it requires a large amount of energy to complete the reaction. Therefore, hydrocarbon cracking must take place under conditions of high temperature and high pressure. The cracking process is facilitated by the presence of a catalytic material and/or by an electrochemical quasi-catalytic reaction.

The present invention takes advantage of the high temperature, high pressure environment of the engine's exhaust gases to create a reaction zone in which the hydrocarbon molecules of the fuel are cracked. The hydrocarbon cracking reaction is facilitated by the insertion into the reaction zone of a reactor rod made of a magnetic material, which is preferably iron. Under the high temperature conditions of the reaction zone, the surface of the iron reactor rod becomes oxidized. It is known that iron oxides act as catalysts for various hydrocarbon cracking processes, as for example, in the hydrocarbon reforming processes taught by Setzer, et al., U.S. Pat. No. 4,451,578.

As ionized fuel molecules and atoms are produced during the cracking process, moreover, their motion around the reactor rod generates an electromagnetic field which magnetizes the iron in the rod. As the iron rod itself magnetizes, the rod generates its own magnetic field, which further ionizes the fuel and accelerates the motion of the ionized particles. These accelerated ions then generate a still stronger electromagnetic field, which in turn induces even greater magnetism in the iron rod. Thus, the electrical-magnetic interaction of the ionized fuel and the reactor rod becomes a feedback loop that drives the process toward ever greater ionization until the complex hydrocarbons in the fuel are broken down into simpler hydrocarbons, which are in a plasma state. This is an electrochemical quasi-catalytic reaction that can proceed even in the absence of a catalytic material in the reactor rod.

The “Background of the Invention” discussion of application Ser. No. 11/889,226, which is incorporated herein by reference, explains that the prior art patents in this field, and specifically Pantone, U.S. Pat. No. 5,794,601, and Jonson, U.S. Pat. No. 7,194,984, fail to provide the proper environment in the reaction zone to sustain an endothermic hydrocarbon cracking process. An important distinction between the present invention and the Pantone and Jonson patents is the total absence in the prior art of either catalytic reactor rods or an electrochemical quasi-catalytic process. Without such catalytic and/or quasi-catalytic reactions, hydrocarbon cracking simply cannot occur in the temperature range of engine exhaust gases. Consequently, the prior art fails to disclose an apparatus and process capable of cracking hydrocarbon fuel and converting it into a genuine plasma so as to truly improve the fuel's combustibility and increase the overall combustion efficiency of the internal combustion engine in which the fuel is burned.

The “Background of the Invention” discussion in application Ser. No. 12/149,961, which is incorporated herein by reference, explains how the “Improved Pre-Ignition Fuel Treatment System” described in application Ser. No. 12/149,961 represents an improvement over the “Pre-Ignition Fuel Treatment System” described in application Ser. No. 11/889,226, insofar as the improved system provides for a multi-pass reaction zone, whereas in the system described in application Ser. No. 11/889,226, the fuel makes only a single pass through the reaction zone.

In the present invention, as in the system described in application Ser. No. 12/149,961, the fuel is re-circulated through the reaction zone in multiple passes until virtually all of the fuel is reformed. After each pass through the reaction zone, the reformed fuel components will be in a plasma state containing large numbers of anions (i.e., negatively charged ions). In order to stabilize the reformed fuel plasma, hydrogen cations (H⁺ ions) are injected downstream of the reaction zone. Still further downstream, the fuel is cooled and condensed, so that the heavier, less volatile unreformed fuel components will revert to a liquid state, while the lighter, more volatile reformed fuel components remain in a gaseous state.

An important difference between the present invention and the system described in application Ser. No. 12/149,961 is that the present invention uses a progressive multi-stage condenser array to further separate the various reformed fuel components. After the unreformed fuel components are liquefied in a primary condenser, the gaseous reformed fuel components pass through an array of one or more secondary condensers, in which fractions of the reformed fuel are condensed in accordance with progressively lower condensation temperatures. The heavier (i.e., higher molecular weight) fractions will condense in earlier stages of the secondary condenser array, in which condensation temperatures are higher, while the lighter (i.e., lower molecular weight) fractions will condense in later stages of the secondary condenser array, in which condensation temperatures are lower.

The present invention also differs from that disclosed in application Ser. No. 12/149,961 insofar as the volume of hydrogen cations (H⁺ ions) injected downstream of the reactor is regulated to control the proportions of lighter versus heavier reformed fuel fractions that are recovered by the secondary condenser array. A greater volume of injected hydrogen cations will produce a relatively higher proportion of the lighter reformed fuel fractions, while a lesser volume of injected hydrogen will produce a higher proportion of the heavier reformed fuel fractions. This is because, in the presence of plentiful hydrogen cations, the cracked hydrocarbon anions will tend to combine with hydrogen only to achieve a neutral, stable molecular form without adding more of the heavier carbon atoms to the molecule. But in the absence of sufficient hydrogen cations, the cracked hydrocarbon anions will tend to combine with hydrocarbon cations, which will make the resulting stable molecule more massive due to the addition of more carbon atoms.

The various stabilized fractions of reformed fuel gas are then stored in one or more auxiliary fuel tanks, while the unreformed liquid fuel is collected in a main fuel tank, from where it is re-circulated back through the reaction zone, and the process is repeated in recurring cycles. From the auxiliary fuel tanks, some of the reformed gaseous fuel is pumped to the engine as needed, while some of it is pumped back into the reaction zone to act as a “carrier-gas” into which atomized unreformed liquid fuel is injected. This latter step enables the present invention to avoid injecting air as a carrier-gas for the atomized fuel entering the reaction zone. As with the system described in application Ser. No. 12/149,961, the present invention thereby averts one of the principal disadvantages of the system disclosed in application Ser. No. 11/889,226, namely the potential for partial combustion of the fuel in the reaction zone due to the presence of oxygen there. Such partial combustion generates pollutants (CO and CO₂) and reduces fuel efficiency. Moreover, the exclusion of air from the reaction zone in the present invention eliminates nitrogen as well as oxygen and thereby prevents the formation of NOₓ pollutants.

Another difference between the present invention and the system disclosed in application Ser. No. 12/149,961 is that some of the separated fractions of the reformed fuel can be used to generate electricity for external use, while other fractions can be withdrawn from the auxiliary fuel tanks and made available for use outside the motor vehicle. Consequently, a motor vehicle implementing the present invention can function as a combination mobile generator and refinery, generating for external use electricity and various grades of reformed hydrocarbon fuel, while at the same time producing sufficient hydrocarbon fuel to power the vehicle's own engine and sustain the hydrocarbon reformation process.

Therefore, the present invention, like the system described in application Ser. No. 12/149,961, represents an improvement over the “Pre-Ignition Fuel Treatment System” described in application Ser. No. 11/889,226 by reforming a greater percentage of the fuel through use of a multi-pass reaction zone, and by eliminating partial fuel combustion and NOₓ formation within the reaction zone. The present invention also has the advantage over the system disclosed in application Ser. No. 12/149,961 of producing not just one type of stabilized reformed gaseous fuel, but multiple grades of stabilized reformed gaseous fuel that can be stored in multiple auxiliary fuel tanks and used as needed in the motor vehicle engine and/or made available for use outside the motor vehicle and/or used to power a generator to supply electricity for use outside the motor vehicle.

The prior art, including this inventor's prior application Ser. No. 11/889,226, has no storage capability for reformed fuel and thus requires continuous operation of the fuel treatment system while the engine is running. This is particularly problematic during the initial cold start of an engine and during rapid acceleration, when the output of reformed fuel will not keep pace with the real-time fuel demand of the engine. The reformed fuel storage capability of the present invention, on the other hand, allows the fuel treatment system of the current invention to cycle on and off as needed to maintain an adequate reserve of reformed gaseous fuel. Unlike the prior art, the present invention maintains the same high level of fuel efficiency and low level of pollutants during cold engine starting and rapid acceleration.

### SUMMARY OF THE INVENTION

It is an object of the present invention to create a reaction zone in a motor vehicle wherein the hydrocarbon fuel is reformed at high temperature and pressure, such that large hydrocarbon molecules are “cracked” to produce smaller, more readily combustible molecules.

It is another object of the present invention to take advantage of the high temperature, high pressure environment of the engine's exhaust gases by locating the reaction zone within the exhaust pipe, such that some of the energy of the exhaust gases is transferred to the fuel molecules and helps induce molecular cracking.

It is another object of the present invention to promote in the reaction zone catalytic and/or electrochemical quasi-catalytic reactions in order to facilitate the hydrocarbon cracking process and to enable that process to take place at a lower temperature and pressure than would otherwise be feasible.

It is another object of the present invention to utilize a reactor rod composed of a material that also has magnetic properties, such that when ions from the cracking process flow around the reactor rod, the rod becomes magnetized and generates a magnetic field which interacts with ionized hydrocarbon molecules, causing them to accelerate.

It is another object of the present invention to create in the reaction zone a positive feedback loop between the magnetization of the reactor rod and the acceleration of the hydrocarbon molecules, such that the accelerated motion of the ionized molecules induces a progressively stronger magnetism in the rod, which in turn generates a stronger magnetic field that further accelerates the molecules.

It is another object of the present invention to utilize the electromagnetic feedback loop created in the reaction zone to accelerate the hydrocarbon fuel molecules to such an elevated energy level that the reformed portion of the fuel is transformed into a plasma.

It is another object of the present invention to crack virtually all of the hydrocarbon fuel molecules by utilizing a multi-pass reaction zone, such that, after each pass through the reaction zone, the treated fuel is cooled, and the larger unreformed hydrocarbon molecules condense into a liquid, which is then separated from the smaller reformed hydrocarbon molecules that remain in a gaseous state, with the unreformed liquid fuel being re-circulated back through the reaction zone.

It is another object of the present invention to produce and recover various grades of reformed fuel by passing the gaseous reformed fuel components through an array of progressively lower temperature secondary condensers downstream of the primary condenser, in which secondary condensers the unreformed fuel components are liquefied and separated out.

It is another object of the present invention to produce and recover one or more grades/fractions of stable reformed hydrocarbon fuel, each of which fractions can be stored and used as needed, by injecting hydrogen cations (H⁺ ions) into the reformed fuel plasma downstream of the reaction zone, so that the hydrogen cations combine with the reformed fuel anions (e.g., CH₃⁻, CH₂⁻, C₂H₅⁻, etc.) to produce stable, neutral molecules of reformed fuel (e.g., CH₄, C₂H₆ , etc.), and by regulating the volume of hydrogen cations to control the proportions of lighter versus heavier reformed fuel fractions that are formed and are recovered by the secondary condenser array.

It is another object of the present invention to avoid the partial combustion of fuel in the reaction zone and the concomitant generation of pollutants (such as CO and NOₓ) by excluding air from the reaction zone and instead using a portion of the reformed gaseous hydrocarbon fuel as a “carrier-gas” into which atomized unreformed fuel is injected at the inlet end of the reaction zone.

It is another object of the present invention to use some of the recovered fractions of reformed fuel to power a generator to produce electricity for use outside the motor vehicle, while other fractions are withdrawn for external use, and still others are used to power the vehicle's engine and to sustain the hydrocarbon reformation process, such that the motor vehicle fuictions as a combined mobile power plant and refinery.

These and other beneficial objects are achieved by a process in which a multi-pass reaction zone is established within the outflow of exhaust gases downstream of the exhaust manifold of an internal combustion engine. The reaction zone comprises a reactor vessel that is installed within the exhaust pipe, such that the exhaust gases flow around the reactor vessel on all sides. The reactor vessel is an oblong plenum formed by a rigid reactor enclosure, which is non-contiguously affixed to the exhaust pipe. Within the reactor enclosure is a reactor rod, which is axially positioned within the reactor vessel such that a uniform annular plenum is formed between the surface of the reactor rod and the walls of the reactor enclosure. The reactor rod is centrally located along the length of the reactor vessel, and it is composed of a material that has magnetic properties and preferably has catalytic properties as well.

On the inlet end of the reactor vessel is an injection assembly, comprising one or more fuel injection ports and one or more carrier-gas injection ports. The fuel injection ports are hydraulically connected to a fuel line, through which a hydrocarbon fuel flows from a main fuel tank. The carrier-gas injection ports are pneumatically connected to an auxiliary fuel tank in which gaseous reformed hydrocarbon fuel is stored.

Downstream of the outlet end of the reactor vessel is a primary condenser in which the partially reformed fuel is cooled, thereby causing the larger, unreformed hydrocarbon molecules to condense as a liquid, while the smaller, reformed hydrocarbon molecules remain as a gas. The unreformed liquid fuel then flows into the main fuel tank, from where it is re-circulated back through the reaction zone. After the unreformed fuel components are liquefied in the primary condenser, the gaseous reformed fuel components pass through an array of one or more secondary condensers, in which fractions of the reformed fuel are condensed in accordance with progressively lower condensation temperatures. The heavier (i.e., higher molecular weight) fractions will condense in earlier stages of the secondary condenser array, in which condensation temperatures are higher, while the lighter (i.e., lower molecular weight) fractions will condense in later stages of the secondary condenser array, in which condensation temperatures are lower.

Upstream of the primary condenser, the partially reformed fuel is injected with hydrogen cations so as to convert the reformed fuel plasma into a stable molecular state in order to facilitate storage of the reformed fuel. The volume of hydrogen cations (H⁺ ions) injected downstream of the reactor is regulated to control the proportions of lighter versus heavier reformed fuel fractions that are recovered by the secondary condenser array. A greater volume of injected hydrogen cations will produce a relatively higher proportion of the lighter reformed fuel fractions, while a lesser volume of injected hydrogen will produce a higher proportion of the heavier reformed fuel fractions.

Each of the various fractions of stabilized reformed fuel is pumped into one of a series of auxiliary fuel tanks, one of which is pneumatically connected to the engine's carburetor and another of which is pneumatically connected to the carrier-gas injection ports.

The mixture of unreformed fuel and reformed carrier-gas (hereafter referred to as the “fuel-gas mixture”) flows within the reactor vessel in the opposite direction to the flow of exhaust gases around the reactor enclosure. At the distal side of this cross-flow process (i.e., the side furthest from the exhaust manifold), the fuel-gas mixture is heated by the exhaust gases to a temperature at which the unreformed fuel is completely vaporized. The vaporized fuel-gas mixture then encounters the reactor rod at its distal end, which preferably has a convex shape to promote laminar flow around it. As the vaporized fuel-gas mixture enters the annular plenum around the reactor rod, its flow path becomes constricted, which causes its pressure and velocity to increase. The increased pressure and kinetic energy of the vaporized fuel-gas mixture is further augmented by its absorption of thermal energy from the exhaust gases, which are becoming progressively hotter as the exhaust manifold is approached.

As the temperature and pressure of the vaporized fuel-gas mixture becomes progressively elevated, some of the vaporized unreformed fuel molecules reach a sufficient energy to become ionized and/or to undergo at the surface of the reactor rod catalytic cracking reactions that produce ionized molecules. The motion of the ionized fuel molecules generates an electromagnetic field around the reactor rod, and this electromagnetic field magnetizes the reactor rod itself. As the reactor rod becomes magnetized, it generates its own magnetic field which causes the motion of the ionized fuel molecules to accelerate. The accelerated motion of the ionized fuel molecules has two effects. First, the accelerated ionic flow generates a stronger electromagnetic field around the reactor rod, which causes the reactor rod to become more strongly magnetized, which then further accelerates the ionic flow. Second, the accelerated flow increases the kinetic energy of the unreformed fuel molecules, thereby increasing the temperature and pressure of the vaporized fuel, so that an increasing number of molecules undergo catalytic and/or quasi-catalytic cracking along the surface of the reactor rod.

The electrochemical quasi-catalytic cracking process occurs as follows: As more fuel molecules ionize and/or crack, more ions are produced and their increasing number and acceleration generates a progressively stronger electromagnetic field around the reactor rod. This strengthening electromagnetic field, in turn, progressively increases the magnetization of the rod. The progressively stronger magnetic field generated by the reactor rod then further accelerates the molecular flow, further increasing the kinetic energy of the molecules and causing more of them to crack and ionize.

Thus, a positive feedback loop is established which drives the hydrocarbon molecules to progressively higher kinetic energy levels. This is an endothermic process that increasingly draws energy from the cross-flow of exhaust gases as those gases become hotter toward the proximal side of the reactor vessel (i.e., the side closest to the exhaust manifold). This positive feedback loop continues until the vaporized fuel-gas mixture reaches the proximal end of the reactor rod and has been ionized to a degree corresponding to the physical state known as plasma.

Like the “Improved Pre-Ignition Fuel Treatment System” disclosed in application Ser. No. 12/149,961, the present invention represents an improvement over the “Pre-Ignition Fuel Treatment System” disclosed in application Ser. No. 11/889,226 in three principal respects:

(1) Recognizing that all of the hydrocarbon fuel molecules will not be cracked in a single pass through the reaction zone, the present invention provides a multi-pass reaction zone, through which the unreformed fuel molecules are re-circulated in multiple passes as many times as it takes to crack them. This multi-pass system assures that virtually 100% of the hydrocarbon fuel molecules will ultimately be cracked, thereby producing a reformed hydrocarbon fuel comprising smaller molecules that are more readily combustible and which generate less pollutants when combusted.

(2) Recognizing that the presence of air in the reaction zone has undesirable consequences, the present invention eliminates the use of air as a carrier-gas for the atomized fuel injected at the inlet end of the reactor vessel and instead uses a portion of the gaseous reformed fuel as a carrier-gas. This airless reaction zone excludes oxygen and nitrogen (except to the extent they are present in the fuel) and thereby prevents the partial combustion of the fuel before it gets to the engine, which reduces overall fuel efficiency. The airless reaction zone also prevents the formation of pollutants such as carbon monoxide, carbon dioxide and oxides of nitrogen.

(3) Recognizing that direct flow of the reformed fuel from the reaction zone to the engine's intake manifold will be insufficient during cold start-up and rapid acceleration, the present invention stabilizes the reformed fuel, thereby allowing it to be stored for use as needed by the engine.

With respect to the “Improved Pre-Ignition Fuel Treatment System” disclosed in application Ser. No. 12/149,961, the present invention has three principal distinguishing features, which enable the present invention to provide a system that operates as a combined mobile power plant and refinery:

(1) While the prior system uses only one condenser and can therefore produce only one grade of reformed hydrocarbon fuel, the present invention has an array of secondary condensers downstream of the primary condenser, with each successive condenser in the secondary array having a progressively lower condensation temperature. In this way, several different fractions of reformed fuel are separately recovered and are separately stored in a series of auxiliary fuel tanks. The various reformed fuel fractions can then be used for different purposes for which they are specifically suited. For example, the lightest fractions, which combust most efficiently and cleanly, can be used to power the vehicle's internal combustion engine, while the heaviest fractions can be reserved for external use and/or used to power an electrical generator, and some of the medium-weight fractions can be re-circulated as the carrier gas in the multi-pass fuel reformation process.

(2) Unlike the prior system, the present invention regulates the volume of hydrogen cations (H⁺ ions) injected downstream of the reactor to control the proportions of lighter versus heavier reformed fuel fractions that are recovered by the secondary condenser array. This feature allows the present invention to “target” the production of certain preferred grades of reformed fuel. If, for example, the unreformed fuel being stored in the main fuel tank is a heavy fuel oil, a higher volume injection of hydrogen cations will produce a relatively greater proportion of gasoline and autogas, while a lower volume injection of hydrogen cations will produce a relatively greater proportion of diesel fuel. Therefore, if production of diesel fuel is preferred, the hydrogen cation injection rate can reduced to optimize diesel production.

(3) While the reformed fuel produced by the prior invention is used exclusively to power the vehicle's internal combustion engine, in the present invention some of the separated fractions of the reformed fuel can be used to generate electricity for external use, while other fractions can be withdrawn from the auxiliary fuel tanks and made available for use outside the motor vehicle. Consequently, a motor vehicle implementing the present invention can function as a combination mobile generator and refinery, generating for external use electricity and various grades of reformed hydrocarbon fuel, while at the same time producing sufficient hydrocarbon fuel to power the vehicle's own engine and sustain the hydrocarbon reformation process.

### BRIEF DESCRIPTION OF THE DRAWINGS

FIG. 1 is a schematic diagram of the motor vehicle fuel reformation system according to the preferred embodiment of the present invention.

FIG. 2 is a cross-sectional view of the reaction zone with the reactor vessel installed in an exhaust pipe according to the preferred embodiment of the present invention.

FIG. 3 is a cross-sectional view of an alternate configuration of the reactor rod component of the present invention.

### DETAILED DESCRIPTION OF THE PREFERRED EMBODIMENT

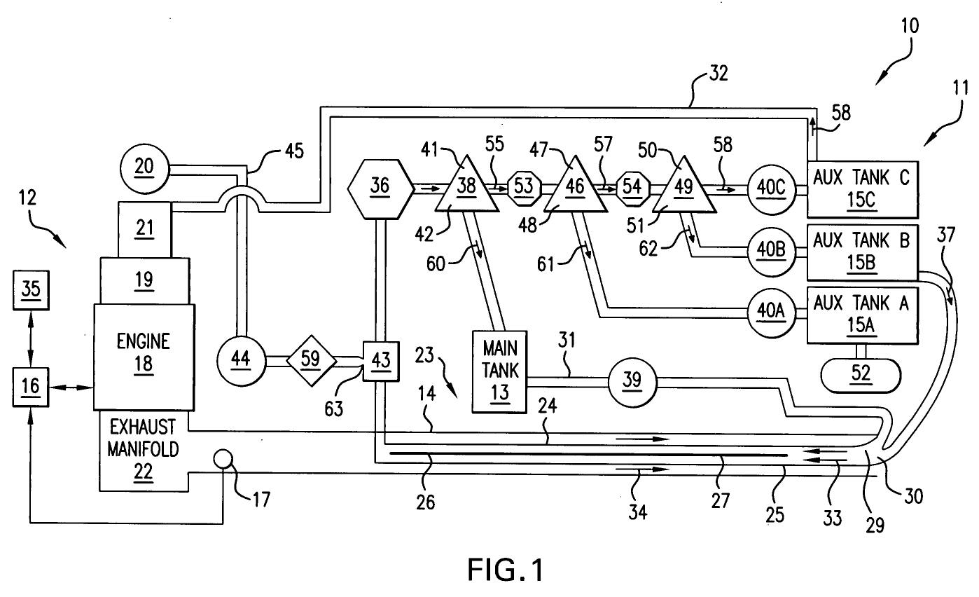

Referring to FIG. 1, a motor vehicle fuel reformation system 10 is installed in a motor vehicle 11 having an internal combustion engine 12, a main fuel tank 13, an exhaust pipe 14, a series of auxiliary fuel tanks 15A, 15B, 15C, an engine control module (ECM) 16, and one or more engine/emissions sensor(s) 17. The main fuel tank 13 stores an unreformed hydrocarbon fuel 60, such as heavy fuel oil, that is mixed with a carrier-gas 37 stored in one of the auxiliary fuel tanks 15B to make a fuel-gas mixture 33. Combustion by-products and excess air, collectively referred to as exhaust gases 34, exit from the vehicle to the external atmosphere through the exhaust pipe 14. The engine/emissions sensors 17 monitor the air-to-fuel ratio and/or the amount of oxygen in the exhaust gases 34.

The engine 12 comprises a combustion zone 18, an intake manifold 19, an air filter 20, a carburetor 21, and an exhaust manifold 22. In the combustion zone 18 a fuel-air mixture is combusted and the exhaust gases 34 are expelled into the exhaust manifold 22, which then expels the exhaust gases 34 into the exhaust pipe 14. The combustion process in the combustion zone 18 has the effect of creating a partial vacuum in the intake manifold 19, which draws air from the external atmosphere into the engine 12 through an air filter 20. The air drawn into the intake manifold 19 is mixed with fuel in the carburetor 21 that is located between the air filter 20 and the intake manifold 19. The air-to-fuel ratio produced by the carburetor 21 is controlled by the ECM 16, which is a microprocessor that computes the optimal air-to-fuel ratio based on the readings of the engine/emissions sensor(s) 17.

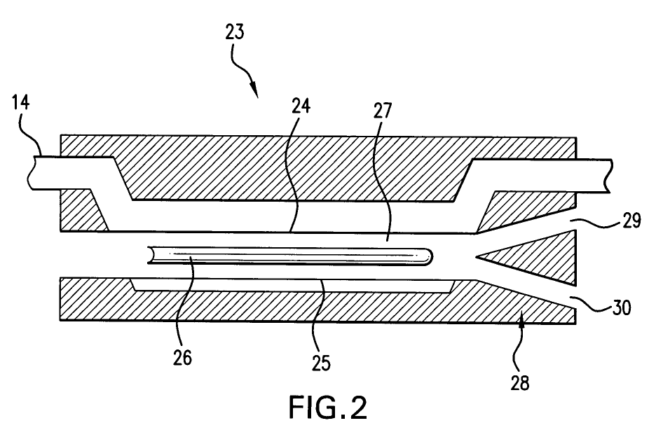

Referring now to both FIG. 1 and FIG. 2, the present invention 10 establishes a multi-pass reaction zone 23 in the exhaust pipe 14 by inserting into a section of the exhaust pipe 14 a reactor vessel 24. The reactor vessel 24 is an oblong plenum formed by a rigid reactor enclosure 25, which is non-contiguously affixed to the exhaust pipe 14. In the preferred embodiment 10, the reactor vessel 24 is a tubular structure fabricated of a material having a high thermal conductivity that can withstand a high temperature, high pressure environment. Optionally, the interior surface of the reactor vessel 24 at its distal end (i.e., the end furthest from the exhaust manifold 22) can be textured to increase its area so as to improve heat transfer across the surface. The reactor vessel 24 is axially installed within the exhaust pipe 14 such that the exhaust gases 34 flow around the entire perimeter of the reactor vessel 24. In the preferred embodiment 10, the longitudinal axis of the reactor vessel 24 is aligned with that of the section of exhaust pipe 14 into which it is inserted.

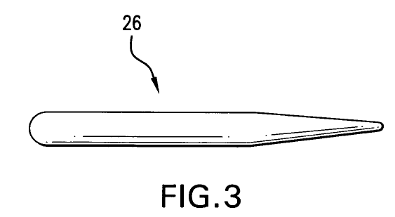

In addition to the reactor enclosure 25, the reactor vessel 24 comprises a reactor rod 26, an annular plenum 27, and an injection assembly 28. The reactor rod 26 is an oblong structure axially positioned within the reactor enclosure 25, such that the annular plenum 27 is formed between the reactor rod 26 and the reactor enclosure 25. In the preferred embodiment, the reactor rod 26 has an elongated cylindrical shape with a convex distal end (i.e., the end furthest from the exhaust manifold 22) and a concave proximal end (i.e., the end closest to the exhaust manifold 22). The diameter of the reactor rod 26 is such that the width of the annular plenum 27 is approximately 1/16 inch. Optionally, the reactor rod 26, can have a slightly tapered diameter in the midsection of the rod. Also optionally, the reactor rod 26 can have a tapered distal side transitioning into a cylindrical proximal side, with both ends being convex, as shown in FIG. 3. The tapered distal end of the latter reactor rod 26 configuration helps reduce turbulence by facilitating a more gradual acceleration of the fuel-gas mixture 33. The length of the reactor rod 26 is in the range of 4 to 12 inches, depending on the type of fuel and the size of the engine 12.

The material composition of the reactor rod 26 is crucial importance to the process of cracking the hydrocarbon fuel and transforming it into a plasma. The reactor rod 26 preferably serves the dual roles of providing a catalyst for the cracking process and participating in the “feedback loop” electromagnetic interaction with ionized fuel molecules, as described hereinabove, which drives the fuel-gas mixture 33 toward a plasma state. In order to fulfill both of these roles, the reactor rod 26 must contain materials that are both highly magnetic and good catalysts for the hydrocarbon cracking process. While the preferred embodiment 10 uses an iron reactor rod 26, other suitable material are steel, nickel, cobalt, rare-earth metals, alloys of the foregoing metals, and magnetic ceramics. Nickel, cobalt and rare-earth metals have known applications as catalysts in hydrocarbon cracking, as disclosed in Cornelius et al., U.S. Pat. No. 4,101,376, Sie, U.S. Pat. No. 4,579,986, and Kumar et al., U.S. Pat. No. 5,248,642, respectively. The reactor rod 26 can also consist of a magnetic core with a catalytic coating or plating. For example, a reactor rod 26 with a steel core covered by a layer of platinum plating is also suitable.

While it is preferable to use a reactor rod 26 having catalytic properties, the present invention 10 does not depend exclusively on a catalytic reactor rod 26. The electrochemical quasi-catalytic reactions promoted by a reactor rod 26 made of a non-catalytic magnetic material are also capable of sustaining the hydrocarbon reformation process.

The shape of the reactor rod 26 is also plays an important role in the cracking and plasma-formation processes. The distal end of the reactor rod 26 has a convex shape, so that the flow of the fuel-gas mixture 33 around the end of the rod is laminar. The goal in forcing the fuel-gas mixture 33 into the constrained annular plenum 27 is to accelerate the flow rate and thereby increase the velocity and kinetic energy of the fuel molecules so that some of them will attain the energy level needed for ionization and cracking to begin. Therefore, turbulent flow around the reactor rod 26 is to be avoided, since turbulence dissipates the molecular kinetic energy and thus retards the ionization and cracking processes. Accordingly, in the preferred embodiment, the proximal end of the reactor rod 26 has a concave shape, which has the effect of creating an area of reduced pressure downstream of the reactor rod 26. This area of reduced pressure has the effect of drawing the flow of fuel-gas mixture 33 evenly along the surface of the reactor rod 26, so that energy-dissipating areas of turbulent flow are avoided.

On the distal end of the reactor vessel 24 is the injection assembly 28, comprising one or more fuel injection port(s) 29 and one or more carrier-gas injection port(s) 30. The fuel injection port(s) are hydraulically connected to a fuel line 31, through which the unreformed hydrocarbon fuel is pumped by a primary pump 39 from the main fuel tank 13. The carrier-gas injection port(s) 30 are pneumatically connected to one of the auxiliary fuel tanks 15B, in which is stored a fraction of gaseous reformed hydrocarbon fuel 37, which serves as the carrier-gas.

Downstream of the proximal end of the reactor vessel 24, is a primary condenser 36, in which the fuel-gas mixture 33 is cooled, thereby causing the larger, unreformed hydrocarbon molecules to condense into a liquid phase, while the smaller, reformed hydrocarbon molecules remain in a gaseous phase. The liquid and gaseous phases separate from one another in a first liquid-vapor separator 38, which comprises an upper first gas chamber 41 and a lower first sump chamber 42.

The liquid unreformed 60 fuel collects in the first sump chamber 42 and is drawn into the main fuel tank 13, which is at lower pressure than the first sump chamber 42. The flow of liquid unreformed fuel 60 from the first sump chamber 42 to the main fuel tank 13 is controlled by a solenoid valve (not shown) based on the liquid level in the first sump chamber 42. From the main fuel tank 13, the unreformed liquid fuel 60 is pumped into the fuel injection port(s) 29 by a primary pump 39, and it is re-circulated through the reactor vessel 24 in multiple passes as many times as it takes to crack it.

A first reformed fuel vapor 55 collects in the first gas chamber 41, from which a secondary pump 40C draws it downstream into an array of secondary condensers 56. For exemplary purposes, the embodiment depicted in FIG. 1 has an array of secondary condensers 56 comprising a second-stage condenser 53 and a third-stage condenser 54. But the number of secondary condensers in the array 56 can be set at any number corresponding to the number of different grades of reformed fuel that the system 10 is designed to produce. In the exemplary embodiment depicted in FIG. 1, the first reformed fuel vapor 55 is further cooled in the second-stage condenser 53, thereby causing a heavy reformed fuel fraction 61 to condense into a liquid phase, while a second reformed fuel vapor 57 remains in a gaseous phase. The liquid and gaseous phases separate from one another in a second liquid-vapor separator 46, which comprises an upper second gas chamber 47 and a lower second sump chamber 48. The heavy reformed fuel fraction 61 is pumped by a secondary pump 40A from the second sump chamber 48 into an auxiliary fuel tank ‘A’ 15A. The flow of heavy reformed fuel 61 from the second sump chamber 48 to the auxiliary fuel tank ‘A’ 15A is controlled by a solenoid valve (not shown) based on the liquid level in the second sump chamber 48.

The second reformed fuel vapor 57 is drawn further downstream in the secondary condenser array 56 by the secondary pump 40C. The second reformed fuel vapor 57 is further cooled in the third-stage condenser 54, thereby causing a medium-weight reformed fuel fraction 62 to condense into a liquid phase, while a light reformed fuel fraction 58 remains in a gaseous phase. The liquid and gaseous phases separate from one another in a third liquid-vapor separator 49, which comprises an upper third gas chamber 50 and a lower third sump chamber 51. The medium-weight reformed fuel fraction 62 is pumped by a secondary pump 40B from the third sump chamber 51 into an auxiliary fuel tank ‘B’ 15B, where a portion of it serves as the carrier gas 37. The flow of medium-weight reformed fuel 62 from the third sump chamber 51 to the auxiliary fuel tank ‘B’ 15B is controlled by a solenoid valve (not shown) based on the liquid level in the third sump chamber 51. The light reformed fuel fraction 58 is pumped by the secondary pump 40C from the third gas chamber 50 into an auxiliary fuel tank ‘C’ 15C.

Between the reactor vessel 24 and the condenser 36 is a hydrogen-mixing manifold 43, in which hydrogen cations (H⁺ ions) are injected into the flow of the fuel- gas mixture 33. The hydrogen cations are generated by an electrolysis cell 44. The hydrogen cations are drawn out of the cathode side of the electrolysis cell 44 by a Venturi injector 63, which utilizes a partial vacuum created by the flow of the fuel-gas mixture 33 across a Venturi opening or tube 63. Between the cathode side of the electrolysis cell 44 and the Venturi injector 63 is a flow control valve 59, which can be set to inject a greater or lesser volume of hydrogen cations into the fuel-gas mixture 33, thereby regulating the relative proportions of the heavy 61, medium-weight 62 and light 58 reformed fuel fractions produced. The hydrogen cations combine with the anions of the reformed hydrocarbon fuel plasma to convert the ions into neutral molecules and thereby stabilize the reformed fuel gas. Optionally, the oxygen anions from the anode side of the electrolysis cell 44 can be injected into the engine's air filter 20 through an oxygen inlet 45 in order to improve combustion.

Each of the heavy 61, medium-weight 62 and light 58 reformed fuel fractions stored, respectively, in the auxiliary fuel tanks ‘A’ 15A, ‘B’ 15B and ‘C’ 15C can be alternately used to: (i) power the vehicle's engine 12, (ii) power an electrical generator 52 to produce electricity for use outside the vehicle, or (iii) serve as a source of fuel to power equipment external to the vehicle. For exemplary purposes, FIG. 1 depicts a system configuration in which the light reformed fuel fraction 58 is drawn through a vacuum conduit 32 into the intake manifold 21 of the engine 12. In the exemplary configuration, the heavy reformed fuel fraction 61 is used to power the electrical generator 52. Also in the exemplary configuration, a portion of the medium-weight reformed fuel fraction 62 is used as the carrier gas 37 and is injected into the reactor vessel 24 through the carrier-gas injection port(s) 30. In the exemplary configuration, the remainder of the medium-weight reformed fuel fraction 62 is a source of fuel to power equipment external to the vehicle.

As an example of how the multi-stage condenser array of the present invention 10 functions, let us consider a vehicle 11 in which heavy fuel oil is the original unreformed fuel 60 that is in the main fuel tank 13. If the primary condenser 36 cools the fuel-gas mixture 33 to a temperature of 300° C., then all hydrocarbon molecules heavier than hexadecane (C₁₆H₃₄) will condense out, such that a heavy fuel oil 60 will collect in the first sump chamber 42 of the first liquid-vapor separator 38 and will be drawn from there into the main fuel tank 13, to be re-circulated back through the multi-pass reaction zone 23 for further cracking and reformation.

The second-stage condenser 53 then receives the first reformed vapor 55 that collects in the first gas chamber 41 of the first liquid-vapor separator 38. If the second-stage condenser 53 cools the first reformed vapor 55 to a temperature of 150° C., then all hydrocarbon molecules heavier than nonane (C₉H₂₀) will condense out, such that a diesel fuel 61 will collect in the second sump chamber 48 of the second liquid-vapor separator 46 and will be drawn from there into auxiliary fuel tank ‘A’ 15A, where can it can be used to power a diesel generator 52.

The third-stage condenser 54 then receives the second reformed vapor 57 that collects in the second gas chamber 47 of the second liquid-vapor separator 46. If the third-stage condenser 54 cools the second reformed vapor 57 to a temperature of 65° C., then all hydrocarbon molecules heavier than hexane (C₆H₁₄) will condense out, such that a gasoline fuel 62 will collect in the third sump chamber 51 of the third liquid-vapor separator 49 and will be drawn from there into auxiliary fuel tank ‘B’ 15B, where some of it can be used as carrier gas 37 and the remainder can be used to power external equipment.

The light reformed fuel fraction 58 that collects in the third gas chamber 50 of the third liquid-vapor separator 49 will then comprise a mixture of methane (CH₄), ethane (C₂H₆), propane (C₃H₈), butane(C₄H₁₀), and pentane (C₅H₁₂), which mixture is commonly known as “autogas” or “liquid petroleum gas” (LPG). In our example, this autogas 58 is drawn by through the vacuum conduit 32 into the LPG carburetor 21 and thence into the intake manifold 19 to power the engine 12.

In the present invention 10, like the invention disclosed in application Ser. No. 12/149,961, but unlike that disclosed in application Ser. No. 11/889,226, the partial vacuum of the intake manifold 19 need no longer be used to create a pressure drop across the reactor vessel 24. Instead, the primary and secondary pumps 39 and 40B create the pressure drop needed to maintain the flow of fuel-gas mixture 33 from the distal to the proximal end of the reactor vessel 24.

The flow direction of fuel-gas mixture 33 through the reactor vessel 24 is in the opposite direction to the flow direction the exhaust gases 34 through the exhaust pipe 14, thus creating a cross-flow that optimizes the transfer to thermal energy from the exhaust gases 34 to the fuel-gas mixture 33. As the fuel-gas mixture 33 is drawn into the reactor enclosure 25 through the injector assembly 28, the cross-flow heats the filel-gas mixture to the point at which the fuel component is vaporized. As the vaporized fuel-gas mixture 33 enters the annular plenum 27 around the reactor rod 26, its flow path becomes constricted, which causes its pressure and velocity to increase. The increased pressure and kinetic energy of the vaporized fuel-gas mixture 33 is further augmented by its absorption of thermal energy from the exhaust gases, which are becoming progressively hotter as the cross-flow approaches the exhaust manifold 22.

As the fuel-gas mixture 33 flows through the annular plenum 27, the unreformed fuel component undergoes the process of ionization, cracking and plasma-formation described hereinabove. At the proximal end of the reactor vessel 24, hydrogen cations from the electrolysis cell 44 are injected into the fuel-gas mixture 33 in order to stabilize the reformed fuel molecules. The fuel-gas mixture 33 then flows into the primary condenser 36 and then to the first liquid-vapor separator 38 where the liquid unreformed fuel 60 is separated from the first reformed fuel vapor 55, with the former being pumped to the main fuel tank 13 and the latter being drawn further downstream into the secondary condenser array 56.

In the exemplary configuration, the light reformed fuel fraction 58 is drawn into the carburetor 21 and the intake manifold 19 through the vacuum conduit 32. In this exemplary configuration, the carburetor 21 will be of the type designed to utilize LPG (liquid petroleum gas), as opposed to a conventional gasoline carburetor. At this juncture, the engine control module (ECM) 16 will determine the appropriate air-to-fuel ratio, which will be set either richer (lower ratio) or leaner (higher ratio) based on the readings of the engine/emissions monitor(s) 17. Since, the ECM 16 bases its determination of air-to-fuel ratio on the stoichiometry of conventional fuel (gasoline or diesel) combustion, its operations must be modified to account for the higher energy content of the light reformed fuel fraction 58 generated by the present invention 10. Therefore, the preferred embodiment of the present invention 10 includes an auxiliary microprocessor 35, which interfaces with the ECM 16 so as to adjust the air-to-fuel ratio to reflect the combustion stoichiometry of the reformed fuel, which is, in this exemplary configuration, the light reformed fuel fraction 58.

An example will illustrate the need for the auxiliary microprocessor 35. Because of the higher energy content of the light reformed fuel fraction 58, less of it will be consumed to release the same amount of energy as conventional fuel. Therefore, its combustion will consume less oxygen, causing the concentration of oxygen in the exhaust gases 34 to rise. This rise will be reflected in the readings of the engine/emissions sensors 17 and communicated to the ECM 16. Since the ECM 16 does its calculations based on the energy content of conventional fuel, its normal response would be to infer from the rise in oxygen concentration in the exhaust gases that the air-to-fuel ratio is too lean. Therefore, the ECM 16 standing alone would, under the circumstances of this example, signal the engine 12 to increase the concentration of fuel being sent to the combustion zone 18. In so doing, however, the ECM 16 would undo the fuel economy advantage of the light reformed fuel fraction 58. When the auxiliary microprocessor 35 interfaces with the ECM 16, however, the air-to-fuel ratio is adjusted to account for the higher energy content of the light reformed fuel fraction 58, thus enabling the present invention 10 to achieve greater savings in fuel consumption.

While this invention has been described with reference to a specific embodiment, the description is not to be construed in a limiting sense. Various modifications of the disclosed embodiment, as well as other embodiments of the invention, will be apparent to persons skilled in the art upon reference to this description. It is therefore contemplated that the appended claims will cover any such modifications or embodiments that fall within the true scope of this invention.

What is claimed is:

1. A method of reforming hydrocarbon fuel comprising:
(a) creating a multi-pass reaction zone within a flow of exhaust gases from an internal combustion engine;
(b) inserting within the reaction zone a reactor vessel having a proximal end and a distal end, which reactor vessel comprises a reactor enclosure, an injection assembly, a reactor rod, and an annular plenum, wherein the reactor rod is an elongated rod composed of a magnetic catalyst material, or a combination of magnetic and catalytic materials, and wherein the reactor rod is axially disposed within the reactor enclosure and is separated from the reactor enclosure by the annular plenum, and wherein the injector assembly is located at the distal end of the reactor vessel;
(c) establishing a pressure differential between within the reactor vessel, such that the pressure at the proximal end is less than the pressure at the distal end;
(d) introducing into the injection assembly a fuel-gas mixture, which is a mixture of an unreformed fuel component composed of heavier hydrocarbon molecules and a reformed fuel component composed of lighter hydrocarbon molecules, such that the pressure differential draws the fuel-gas mixture through the reactor vessel from the distal end to the proximal end;
(e) establishing a cross-flow between the exhaust gases and the fuel-gas mixture, wherein the exhaust gases flow around the reactor enclosure from the proximal end to the distal end, while the fuel-gas mixture flows within the reactor enclosure from the distal end to the proximal end;
(f) transferring thermal energy from the exhaust gases to the fuel-gas mixture by means of the cross-flow;
(g) vaporizing the fuel-gas mixture with the thermal energy transferred from the exhaust gases as the fuel-gas mixture flows toward the annular plenum;
(h) drawing the fuel-gas mixture into the annular plenum by means of the pressure differential, and thereby creating a constricted flow, in which the hydrocarbon molecules of the fuel component attain an elevated energy level;
(i) initiating a cracking of the hydrocarbon molecules of the fuel component at the elevated energy level, such that the vaporized unreformed fuel component becomes a partially-cracked fuel component having a lighter cracked fuel fraction and a heavier uncracked fuel fraction;
(j) providing downstream of the reactor vessel a hydrogen mixing manifold, wherein hydrogen cations generated by an electrolysis cell are injected into the fuel-gas mixture, such that the hydrogen cations combine with anions comprising the cracked fuel fraction of the partially-cracked fuel component to produce stable, neutral reformed hydrocarbon molecules that become part of and augment the reformed fuel component of the fuel-gas mixture;
(k) passing the fuel-gas mixture through a primary condenser that causes the temperature of the fuel-gas mixture to drop, such that the uncracked fuel fraction of the partially-cracked fuel component condenses into a liquid, which becomes a reconstituted unreformed fuel component, while the augmented reformed fuel component remains a gas;
(l) passing the fuel-gas mixture into a primary liquid-vapor separator that has a primary sump chamber, in which the reconstituted unreformed fuel component collects, and a primary gas chamber, in which the gaseous augmented reformed fuel component collects;
(m) passing the gaseous augmented reformed fuel component through an array of one or more secondary condensers, such that each successive secondary condenser causes the temperature of the reformed fuel component to be incrementally reduced, thereby condensing a plurality of reformed fuel fractions from the reformed fuel component, with each successive secondary condenser condensing a more volatile reformed fuel fraction than the previous secondary condenser;
(n) passing each of the plurality of reformed fuel fractions into one of a series of secondary liquid-vapor separators having secondary sump chambers, in which each of the reformed fuel fractions separately collects, and having secondary gas chambers, in which an uncondensed remainder of the gaseous reformed fuel component collects;
(o) collecting and storing the liquid reconstituted unreformed fuel component in a main fuel tank;
(p) collecting and storing the reformed fuel fractions and the uncondensed remainder of the gaseous reformed fuel component in a series of auxiliary fuel tanks;
(q) from one or more of the auxiliary fuel tanks, drawing a portion of the reformed fuel fractions and/or the uncondensed remainder of the gaseous reformed fuel component into the internal combustion engine and combusting it;
(r) creating a second-generation fuel-gas mixture by mixing a portion of the reformed fuel fractions and/or the uncondensed remainder of the gaseous reformed fuel component with the reconstituted unreformed fuel component;
(s) introducing the second-generation fuel-gas mixture into the injection assembly of the reactor vessel; and
(t) repeating steps (d) through (s), such that the second-generation fuel-gas mixture yields a third-generation fuel-gas mixture, which in turn yields a fourth-generation fuel-gas mixture, and so on until the entire unreformed fuel component is completely cracked and becomes part of and augments the reformed fuel component.

2. The method according to claim 1, comprising the additional step (jk) between step (j) and step (k), as follows:
(jk) regulating the volume of hydrogen cations injected into the hydrogen mixing manifold so as to control the relative proportions of lighter versus heavier components of the reformed fuel fractions and/or the relative proportions of the reformed fuel fractions versus the uncondensed remainder of the gaseous reformed fuel component;

3. The method according to either claim 1 or 2, comprising the additional step (qr) between step (q) and step (r), as follows:
(qr) from one or more of the auxiliary fuel tanks, extracting a portion of the reformed fuel fractions and/or the uncondensed remainder of the gaseous reformed fuel component to power an electrical generator and/or other equipment;

4. The method according to either claim 1 or 2, comprising the additional step (pq) between step (p) and step (q) as follows:
(pq) diluting the reformed fuel fractions and/or the uncondensed remainder of the gaseous reformed fuel component with air in an air-to-fuel ratio as determined by an engine control module interfacing with an auxiliary microprocessor, such that the auxiliary microprocessor adjusts the air-to-fuel ratio to account for the enhanced energy content of the reformed fuel fractions and/or the uncondensed remainder of the gaseous reformed fuel component;

5. The method according to claim 3, comprising the additional step (pq) between step (p) and step (q) as follows:
(pq) diluting the reformed fuel fractions and/or the uncondensed remainder of the gaseous reformed fuel component with air in an air-to-fuel ratio as determined by an engine control module interfacing with an auxiliary microprocessor, such that the auxiliary microprocessor adjusts the air-to-fuel ratio to account for the enhanced energy content of the reformed fuel fractions and/or the uncondensed remainder of the gaseous reformed fuel component;

6. An apparatus for reforming hydrocarbon fuel comprising:
(a) a multi-pass reaction zone within an exhaust pipe of a vehicle powered by an internal combustion engine, which multi-pass reaction zone has axially disposed within it a reactor vessel;
(b) a reactor vessel having a proximal end and a distal end, which reactor vessel comprises a reactor enclosure, an injection assembly, a reactor rod, and an annular plenum, wherein the reactor rod is composed of a magnetic material, or a catalytic material, or a combination of magnetic and catalytic material, and wherein the reactor rod is axially disposed within the reactor enclosure and is separated from the reactor enclosure by the annular plenum, and wherein the injection assembly is located at the distal end of the reactor vessel;
(c) a fuel-gas mixture, which flows in multiple repeated cycles into the reactor vessel from the injector assembly and then flows through the reactor vessel from the distal end to the proximal end, and which fuel-gas mixture is a mixture of a reformed fuel component composed of lighter hydrocarbon molecules and an unreformed fuel component composed of heavier hydrocarbon molecules, which unreformed fuel component undergoes a cracking process in each cycle which progressively transforms the fuel-gas mixture, such that the reformed fuel component is augmented during each cycle, and after each cycle a portion of the augmented reformed fuel component is combusted in an internal combustion engine;
(d) a hydrogen mixing manifold located downstream of the reactor vessel, wherein hydrogen cations generated by an electrolysis cell are injected into the fuel-gas mixture to produce stable, neutral reformed hydrocarbon molecules that become part of and augment the reformed fuel component of the fuel-gas mixture; and
(e) a series of condensers and liquid-vapor separators, which, after each cycle, separate and collect from the fuel-gas mixture the unreformed fuel component and one or more fractions of the reformed fuel based on their boiling points.

7. The apparatus according to claim 6, further comprising a flow control means between the electrolysis cell and the hydrogen mixing manifold, which flow control means regulates the volume of hydrogen cations injected into the hydrogen mixing manifold so as to control the relative proportions of lighter versus heavier components of the reformed fuel fractions produced by the apparatus.

8. The apparatus according to either claim 6 or 7, further comprising one or more auxiliary fuel tanks, from which are extracted a portion of the reformed fuel fractions to power an electrical generator and/or other equipment.

9. The apparatus according to either claim 6 or 7, comprising the additional elements of an engine control module (ECM) digitally interfaced with an auxiliary microprocessor, such that the ECM in concert with the auxiliary microprocessor determines an air-to-fuel ratio in the internal combustion engine which accounts for the enhanced energy content of the reformed fuel component.

10. The apparatus according to claim 8, comprising the additional elements of an engine control module (ECM) digitally interfaced with an auxiliary microprocessor, such that the ECM in concert with the auxiliary microprocessor determines an air-to-fuel ratio in the internal combustion engine which accounts for the enhanced energy content of the reformed fuel component.
